(19) United States
(12) Patent Application Publication
(10) Pub. No.: US 2011/0274885 A1
(43) Pub. Date: Nov. 10, 2011

(54) ABRASIVE INSERTS

(76) Inventors: Cornelis Roelof Jonker, Springs (ZA); Robert Fries, Springs (ZA)

(21) Appl. No.: 13/145,822

(22) PCT Filed: Jan. 22, 2010
(86) PCT No.: PCT/IB10/50280

§ 371 Date: Jul. 22, 2011

(30) Foreign Application Priority Data
Jan. 22, 2009 (ZA) 2008/10609

(51) Int. Cl. B32B 5/16; B32B 37/06; B32B 37/10; B32B 18/00

(52) U.S. Cl. 428/172; 428/325; 156/60

(57) ABSTRACT

The invention relates to an abrasive insert comprising a layer of PCD or PCBN; and a cemented carbide substrate to which the layer of PCD or PCBN is bonded through an interlayer; the interlayer comprising a bonded mass of superhard abrasive particles and refractory particles wherein an average size of the superhard abrasive particles is the same as or less than that of the refractory particles and to a method of manufacture of the insert.

### BACKGROUND OF THE INVENTION

The present invention relates to abrasive inserts and particularly to abrasive inserts for use in roller cone type bits and percussion type bits and in mining picks.

Roller cone rock bits are widely used for oil, gas, and geothermal drilling operations. In general, roller cone rock bits include a body connected to a drill string and typically three hollow cutter cones each mounted on journals on the bit body for rotation about an axis transverse to the axis of the drill bit. In use, the drill string and bit body are rotated in the bore hole and each cone is caused to rotate on its respective journal as the cone contacts the bottom of the bore hole being drilled.

A percussive hammer drill penetrates rock by striking a drill bit with a piston located within the drill body. These drills can be operated using air, water or oil but the most common medium is air. Contact with the rock is made via button bits where cylindrical button inserts typically hemispherical or ballistic in shape are pressed into the face of the bit. Percussion-type bits are rotary-percussive tools, their function is to impact-fracture the material being drilled.

The abrasive inserts for roller cone and percussion type bits are generally made of cemented carbide, particularly cemented tungsten carbide, or polycrystalline diamond (PCD). Polycrystalline diamond abrasive inserts are generally bonded to a cemented carbide support or substrate. PCD abrasive inserts have the advantage of greater abrasion resistance over cemented carbide abrasive inserts.

Picks are used as cutting tools in machinery used in such applications as the mining of coal, the tunnelling through of rock and in road surfacing. The term “pick” typically means a pointed or chisel shaped rock cutting tool which cuts rock by penetrating and scraping along the surface of the rock. Picks typically consist of a steel shank with a tungsten carbide-cobalt or PCD material forming the cutting tip.

PCD, also known as a diamond abrasive compact, tends to be brittle and in use such materials are frequently bonded to a cemented carbide substrate to afford support. Such supported abrasive compacts are known in the art as composite diamond abrasive compacts. Composite diamond abrasive compacts may be used as such in a working surface of an abrasive tool.

Polycrystalline cubic boron nitride (PCBN), also known as a cubic boron nitride abrasive compact, is another superhard abrasive material which can, in use, be bonded to a substrate such as a cemented carbide substrate.

Abrasive compacts bonded to a cemented carbide substrate made at HPHT conditions are brought into or close to an equilibrium state at those conditions. Bringing the compacts to conditions of normal temperature and normal pressure induces large stresses in the abrasive compact due to the different thermal and mechanical/elastic properties of the abrasive layer and the substrate. The combined effect is to place the abrasive layer in a highly stressed state. Finite element analysis shows that the abrasive layer may be in tension in some regions whilst being in compression elsewhere. The nature of the stresses is a complex interaction of the conditions of manufacture, the nature of the materials of the abrasive layer and the substrate, and the nature of the interface between the abrasive layer and the substrate, amongst others. In service, such a stressed abrasive compact is predisposed to premature failure by spalling, delamination and other mechanisms. That is to say, the abrasive compact fails prematurely due to separation and loss of all or part of the abrasive layer from the cutting surface of the abrasive compact, and the higher the residual stresses, the greater is the probability of premature failure.

This problem is well recognised in the industry and there have been a number of techniques applied in an attempt to solve it.

Various abrasive compact structures have been proposed in which the interface between the abrasive layer and the supporting substrate contains a number of ridges, grooves, indentations or asperities of one type or another aimed at reducing the susceptibility of the interface to mechanical and thermal stresses. Such structures are taught, for example, in U.S. Pat. Nos. 4,784,203, 5,011,515, 5,486,137, 5,564,511, 5,906,246 and 6,148,937. In effect, these patents focus on distributing the residual stresses over the largest possible area.

U.S. Pat. No. 6,189,634 teaches that providing a hoop of polycrystalline diamond extending around the periphery of the abrasive compact in addition to the normal polycrystalline layer on the substrate surface reduces residual stresses in the compact. The combination of a peripheral hoop of polycrystalline diamond and a non-planar, profiled interface is taught in U.S. Pat. No. 6,149,695. In this case, the projections into the substrate and into the polycrystalline diamond layer are claimed substantially to balance and modify the residual stresses allowing the abrasive compact to withstand greater imposed loads and cutting forces. U.S. Pat. No. 6,189,634 teaches, amongst its numerous embodiments, a similar stress reduction method.

Extending one or more protrusions from the substrate through the abrasive layer to present an area of substrate on the working surface of the composite abrasive compact is another solution to the problem offered by U.S. Pat. Nos. 5,370,717, 5,875,862 and 6,189,634.

Further examples of composite abrasive compacts which have non-planar interfaces can be found described in U.S. Pat. Nos. 5,154,245, 5,248,006, 5,743,346, 5,758,733, 5,848,657, 5,871,060, 5,890,552, 6,098,730, 6,102,143 and 6,105,694.

Whilst non-planar interfaces can improve the resistance of the inserts to delamination compared with a standard planar interface, they are subject to a number of intrinsic limitations:
The peak residual interface stresses between substrate and PCD layer are still present and only locally reduced.
Cobalt pools are present at the PCD carbide interface regardless of interface geometry resulting in an intrinsically weak bond. This is substantially absent when interlayers are used.
Non-planar interfaces introduce undesirable complexities into substrate manufacture and subsequent high-pressure sintering via non linear shrinkage and associated difficulty in shape control.

Another method applied in attempting to solve the problem of a highly stressed composite abrasive compact is to provide one or more interlayers of a different material with properties, particularly thermal and mechanical/elastic properties, intermediate between the properties of the substrate and the abrasive layer. The purpose of such interlayers is to accommodate some of the stresses in the interlayers and thereby reduce the residual stresses in the abrasive layer.

This method is exemplified by U.S. Pat. No. 5,510,193 which provides for an interlayer of sintered polycrystalline cubic boron nitride. Another example is U.S. Pat. No. 5,037,704 which allows the interlayer to comprise cubic boron nitride with aluminium or silicon and at least one other component selected from the group comprising the carbides, nitrides and carbonitrides of the elements of Groups 4A, 5A and 6A of the Periodic Table of the Elements. A further example, U.S. Pat. No. 4,959,929, teaches that the interlayer may comprise 40% to 60% by volume cubic boron nitride together with tungsten carbide and cobalt.

In yet another approach, U.S. Pat. No 5,469,927 teaches that the combination of a non-planar interface and transition layers may be used. In particular, this patent describes the use of a transition layer of milled polycrystalline diamond with tungsten carbide in the form of both particles of tungsten carbide alone and pre-cemented tungsten carbide particles. Furthermore, there is provision for tungsten metal to be mixed into the transition layer to enable excess metal to react to form tungsten carbide in situ.

Further examples of composite diamond abrasive compacts having one or more interlayers can be found described in U.S. Pat. Nos. 3,745,623, 4,403,015, 4,604,106, 4,694,918, 4,729,440, 4,807,402, 5,370,195, 5,469,927, 6,258,139 and 6,315,065 and US Patent Publication No. 2006/0166615 A1.

These interlayers have limitations, particularly:
They reduce peak stresses between PCD and substrate but are intrinsically weak;
Generally the diamond acts as a flaw, reducing strength;
Poor diamond to cemented carbide substrate bonding, leading to pull out of particles in wear situations.

### SUMMARY OF THE INVENTION

According to the present invention, an abrasive insert comprises:
a layer of PCD or PCBN; and
a cemented carbide substrate to which the layer of PCD or PCBN is bonded through an interlayer;
the interlayer comprising a bonded mass of superhard abrasive particles and refractory particles wherein an average size of the superhard abrasive particles is the same as or less than that of the refractory particles.

### DESCRIPTION OF EMBODIMENTS OF THE INVENTION

The invention relates to abrasive inserts which comprise composite abrasive compacts. The abrasive inserts are characterized by an interlayer between the PCD or PCBN layer and the cemented carbide substrate. This interlayer comprises a bonded mass of superhard abrasive particles and refractory particles wherein the size of the superhard abrasive particles is the same as or less than that of the refractory particles. In this interlayer the superhard abrasive particles and the refractory particles will generally be present as discrete entities with little or no or substantially no intergrowth or direct particle-to-particle bonding. A bonding phase will also be present. This bonding phase will generally be the same as, or similar to, that for PCD or PCBN layer.

The amount of superhard abrasive particle in the interlayer will generally be in the range 10 to 90 on a volume percent basis.

The superhard abrasive will be diamond or cubic boron nitride. Generally, for an abrasive insert having a PCD layer, the superhard abrasive will be diamond and when the layer is a PCBN layer, the superhard abrasive will be cubic boron nitride. A mixture of superhard abrasive particles may be present in the interlayer.

The refractory particles may be carbide, nitride, boride or like refractory particles. Carbide particles are preferred.

The size of the superhard abrasive particles are the same as or less than that of the refractory particles. When size of the superhard abrasive particles is less than that of the refractory particles, they will generally have a size of 10 microns, preferably 5 microns or less than that of the refractory particles.

The thickness of the interlayer will vary according to the nature of the abrasive insert and its intended application. Generally, the thickness of the interlayer will be in the range 100 to 2000, typically 200 to 500 microns.

The abrasive insert of the invention has an interlayer as defined above between the PCD or PCBN layer and the cemented carbide substrate. The interlayer will generally have a region in contact with and bonded to the PCD or PCBN layer and a region in contact with and bonded to a surface of the cemented carbide substrate. An additional interlayer or interlayers may also be provided between the superabrasive/carbide interlayer and PCD or PCBN layer andor between the superabrasive/carbide interlayer and the cemented carbide substrate.

The PCD or PCBN layer may be of a fine grain or coarse grain type. The thickness will vary according to the nature and particle size of the layer. Generally, the thickness of this superabrasive layer will be in the range 0.1 to 4 mm.

The cemented carbide of the substrate may be any known in the art such as cemented tungsten carbide, cemented tantalum carbide, cemented molybdenum carbide or cemented titanium carbide. Such cemented carbides, as is known in the art, have a bonding phase such as nickel, cobalt, iron or alloys containing one or more of these metals. Typically, the bonding phase is present in the amount of 6 to 20% by mass. When the PCD or PCBN layer is a thick layer, i.e. has a thickness of at least 2.5 mm, it is preferred that the bonding phase of the cemented carbide is less than 9-10% by mass and preferably less than 8% by mass, e.g. 6% by mass.

The abrasive insert may have any suitable shape, depending on the application to which it will be put. For example, the abrasive insert may have a disc shape with an upper flat working surface defining a cutting edge around its periphery. The invention has particular application to abrasive inserts which are shaped, e.g. where the superabrasive layer presents a bullet or dome shape which provides the working surface for the insert.

The abrasive insert of the invention may be made by a method which comprises the steps of:
(1) providing a cemented carbide substrate;
(2) placing a mixture of superhard abrasive particles and refractory particles, in layer form, on a surface of the substrate, wherein an average size of the superhard abrasive particles is the same or less than that of the refractory particles;
(3) placing a layer of diamond or cubic boron or a mixture thereof, with optionally a bonding phase, onto the layer of superabrasive particles and refractory particles; and
(4) subjecting this unbonded assembly to compact synthesis conditions.

The unbonded assembly is placed in a suitable reaction capsule which is then placed in the reaction zone of a known high pressure/high temperature apparatus. The contents of the reaction capsule are subjected to compact synthesis conditions, as is known in the art. These conditions for typically be a pressure of 5 to 8 GPa and a temperature of 1300 to 1600 degrees centigrade. The bonded abrasive insert is recovered from the reaction capsule, again by methods known in the art.

The invention will now be described with reference to the following non-limiting example.

### EXAMPLE 1

An abrasive insert which comprised composite abrasive compacts according to the invention was manufactured as follows.

The amount of superhard diamond abrasive particle in the interlayer was 50 on a volume percent basis.

The superhard abrasive was diamond. The refractory particles were carbide refractory particles.

The size of the superhard diamond abrasive particles was 5 microns or less than that of the refractory particles.

The thickness of the interlayer was 300 microns.

The abrasive insert had an interlayer between the PCD layer and the cemented carbide substrate. The interlayer had a region in contact with and bonded to the PCD layer and a region in contact with and bonded to a surface of the cemented carbide substrate.

The PCD was of coarse grain type. The thickness this superabrasive PCD layer was 1.0 mm.

The cemented carbide of the substrate was cemented tungsten carbide Such cemented carbide had a bonding phase of an alloy containing nickel. The bonding phase was present in the amount of 10% by mass.

The abrasive insert had a disc shape with an upper flat working surface defining a cutting edge around its periphery.

The abrasive insert of the invention was made by a method which comprised the steps of:
(1) providing a cemented carbide substrate;
(2) placing a mixture of the diamond particles and carbide refractory particles, in layer form, on a surface of the substrate;
(3) placing a layer of diamond abrasive particles onto the layer of diamond particles and carbide refractory particles; and
(4) subjecting this unbonded assembly to compact synthesis conditions.

The unbonded assembly was placed in a suitable reaction capsule which was then placed in the reaction zone of a known high pressure/high temperature apparatus. The contents of the reaction capsule were subjected to compact synthesis conditions of a pressure of 6 GPa and a temperature of 1450 degrees centigrade. The bonded abrasive insert was recovered from the reaction capsule, again by methods known in the art.

1. An abrasive insert comprising:
a layer of PCD or PCBN; and
a cemented carbide substrate to which the layer of PCD or PCBN is bonded through an interlayer;
the interlayer comprising a bonded mass of superhard abrasive particles and refractory particles wherein an average size of the superhard abrasive particles is the same as or less than that of the refractory particles.

2. An abrasive insert according to claim 1 wherein the superhard abrasive particles and the refractory particles are present as discrete entities with no or substantially no intergrowth or direct particle-to-particle bonding.

3. An abrasive insert according to claim 1 wherein the interlayer also comprises a bonding phase.

4. An abrasive insert according to claim 3 wherein the bonding phase is the same as, or similar to, that for the PCD or PCBN layer.

5. An abrasive insert according to claim 1 wherein the amount of superhard abrasive particle in the interlayer is in the range 10 to 90 on a volume percent basis.

6. An abrasive insert according to claim 1 wherein the superhard abrasive is diamond or cubic boron nitride or a mixture thereof.

7. An abrasive insert according to claim 1 wherein the refractory particles are carbide, nitride, boride or like refractory particles.

8. An abrasive insert according to claim 1 wherein the superhard abrasive particles have a size of 10 microns or less than that of the refractory particles.

9. An abrasive insert according to claim 1 wherein the thickness of the interlayer is in the range 100 to 2000 microns.

10. An abrasive insert according to claim 1 including an additional interlayer or interlayers provided between the superabrasive/carbide interlayer and PCD or PCBN layer and/or between the superabrasive/carbide interlayer and the cemented carbide substrate.

11. An abrasive insert according to claim 1 wherein the PCD or PCBN layer is of a fine grain or coarse grain type.

12. An abrasive insert according to claim 1 wherein the thickness of the superabrasive layer is in the range 0.1 to 4 mm.

13. An abrasive insert according to claim 1 wherein the cemented carbide of the substrate is selected from cemented tungsten carbide, cemented tantalum carbide, cemented molybdenum carbide and cemented titanium carbide.

14. An abrasive insert according to claim 3 wherein the bonding phase is present in an amount of 6 to 20% by mass.

15. An abrasive insert according to claim 3 wherein, when the PCD or PCBN layer has a thickness of at least 2.5 mm, the bonding phase of the cemented carbide is less than 9-10% by mass.

16. An abrasive insert according to claim 1 which is shaped to a bullet or dome shape.

17. A method for the manufacture of an abrasive insert according to claim 1 which method comprises the steps of:
placing a mixture of superhard abrasive particles and refractory particles, in layer form, on a surface of a cemented carbide substrate, wherein an average size of the superhard abrasive particles is the same or less than that of the refractory particles;
placing a layer of diamond or cubic boron or a mixture thereof, with optionally a bonding phase, onto the layer of superabrasive particles and refractory particles; and
subjecting this unbonded assembly to compact synthesis conditions.

18. A method according to claim 17 wherein the unbonded assembly is placed in a suitable reaction capsule which is then placed in the reaction zone of a known high pressure/high temperature apparatus.

19. A method according to claim 17 wherein the contents of the reaction capsule are subjected to a pressure of 5 to 8 GPa and a temperature of 1300 to 1600 degrees centigrade.
